(19) United States
(12) Patent Application Publication
(10) Pub. No.: US 2025/0320770 A1
(43) Pub. Date: Oct. 16, 2025

(54) SKINNED DOOR PANELS WITH REPLACEMENT BOTTOM RAILS

(71) Applicant: ANDERSEN CORPORATION, Bayport, MN (US)

(72) Inventors: Audrey Eigner, White Bear Lake, MN (US); Todd Bruchu, Lake Elmo, MN (US)

(21) Appl. No.: 19/173,368

(22) Filed: Apr. 8, 2025

Related U.S. Application Data
(60) Provisional application No. 63/632,061, filed on Apr. 10, 2024.

(51) Int. Cl. E06B 3/82; E06B 7/16

(52) U.S. Cl. CPC E06B 3/822; E06B 7/16

(57) ABSTRACT

Skinned door panels with replacement bottom rails and related methods are described herein. The skinned door panels with bottom rail replacements and related methods of replacing bottom rails in door panels having a trimmed bottom edge include a replacement bottom rail that is particularly resistant to moisture penetration allowing for convenient modification of the height of the door panels without degrading their long-term viability in use.

### RELATED APPLICATION

This application claims the benefit under 35 U.S.C. Section 119 of U.S. Provisional Patent Application Ser. No. 63/632,061 entitled “SKINNED DOOR PANELS WITH REPLACEMENT BOTTOM RAILS” as filed on Apr. 10, 2024, which is incorporated herein by reference in its entirety.

Skinned door panels with replacement bottom rails and related methods are described herein.

Modern door panels used for, e.g., entry doors are often constructed of outer skins position between stiles that extend vertically along the edges of the door panels with, often, filler material such as, e.g., foam, wood, etc. located between the outer skins to provide desired characteristics to the door panels such as, e.g., stiffness, sound deadening, thermal insulation, etc. The skins of the doors are typically manufactured of durable materials such as, e.g., metal, fiberglass, polymer composites, wood, wood composites, etc. The bottom edges of the door panels typically include a bottom rail extending between the edges of the door panels to, e.g., provide further structural integrity to the door panel itself.

### SUMMARY

Skinned door panels with replacement bottom rails and related methods are described herein.

Although skinned door panels provide a number of advantages over solid doors adjustment of the height of the door panels after manufacturing can result in door panels having bottom edges that are susceptible to moisture penetration into the interior of the door panels between the skins that can result in swelling mold formation, rot, etc.—all of which can lead to premature failure of the door panels. Despite those disadvantages, skinned door panels may, in some instances, require trimming along their bottom edges to shortened the door panels so that they fit within some building/rough openings.

In one or more embodiments, the skinned door panels with bottom rail replacements and related methods of replacing bottom rails in door panels having a trimmed bottom edge result in a replacement bottom rail that is particularly resistant to moisture penetration allowing for convenient modification of the height of the door panels without degrading their long-term viability in use.

In one or more embodiments, the door panels described herein may include sealant cavities containing sealant located between the replacement bottom rail and each of the skins, with the sealant providing robust protection against moisture penetration into the interior of the door panels between the exterior skins.

In one or more embodiments, the door panels described herein may include a sealant cavity including sealant located therein between the replacement bottom rail and the skins as well as between the ends of the replacement bottom rail and the stile caps positioned between the skins along the vertical edges of the door panels.

In a first aspect, one or more embodiments of a door panel including a replacement bottom rail as described herein includes: a first skin and a second skin positioned opposite from each other on opposite major sides of the door skin, wherein each of the first skin and the second skin comprise a bottom edge, a first side edge, and a second side edge; a first composite stile positioned between the first side edges of the first skin and the second skin, the first composite stile comprising a first stile cap exposed between the first edge of the first skin and the first edge of the second skin, and a first interior stile located inward from the first stile cap, wherein the first stile cap extends from the bottom edges of the first skin and the second skin to a top edge of the door panel, and wherein the first interior stile comprises a first inset end spaced inward from the bottom edges of the first skin and the second skin and a bottom end of the first stile cap; a second composite stile positioned between the second side edges of the first skin and the second skin, the second composite stile comprising a second stile cap exposed between the second edge of the first skin and the second edge of the second skin, and a second interior stile located inward from the second stile cap, wherein the second stile cap extends from the bottom edges of the first skin and the second skin to a top edge of the door panel, and wherein the second interior stile comprises a second inset end spaced inward from the bottom edges of the first skin and the second skin and a bottom end of the second stile cap; and a bottom rail located between the bottom edges of the first skin and the second skin, the bottom rail positioned in a pocket defined by the first skin, the second skin, the inset ends of the first and second interior stiles, the first stile cap, and the second stile cap. The bottom rail comprises: a first end proximate the first stile cap and a second end proximate the second stile cap, an interior face extending from the first end to the second end, the interior face facing towards the first inset end of the first interior stile and the second inset end of the second interior stile, an exterior face facing away from the first bottom end of the first interior stile and the second bottom end of the second interior stile, and a side surface extending between the interior face and the exterior face of the bottom rail about a perimeter of each of the interior face and the exterior face. The door panel further includes a first side sealant cavity located between the side surface of the bottom rail and the first skin; a second side sealant cavity located between the side surface of the bottom rail and the second skin; and flowable sealant located in the first side sealant cavity and the second side sealant cavity.

In one or more embodiments, the door panels described herein include a first end sealant cavity located between the side surface of the bottom rail and the first stile cap proximate the first end of the bottom rail; a second end sealant cavity located between the side surface of the bottom rail and the second stile cap proximate the second end of the bottom rail; and flowable sealant located in the first end sealant cavity and the second end sealant cavity. In one or more embodiments, the first side sealant cavity, the second side sealant cavity, and the first end sealant cavity comprise a continuous sealant cavity, and wherein the flowable sealant in the first side sealant cavity, the second side sealant cavity, and the first end sealant cavity extends continuously from the first side sealant cavity to the second side sealant cavity through the first end sealant cavity. In one or more embodiments, the first side sealant cavity, the second side sealant cavity, the first end sealant cavity, and the second end sealant cavity comprise a continuous sealant cavity, and wherein the flowable sealant in the first side sealant cavity, the second side sealant cavity, the first end sealant cavity, and the second end sealant cavity extends continuously from the first side sealant cavity to the second side sealant cavity through the first end sealant cavity and the second end sealant cavity.

In one or more embodiments of the door panels described herein, the bottom rail defines a first side sealant cavity gap between the side surface of the bottom rail and the first skin along the bottom edge of the first skin and a second side sealant cavity gap between the side surface of the bottom rail and the second skin along the bottom edge of the second skin. In one or more embodiments, the door panel comprises: a first end sealant cavity located between the side surface of the bottom rail and the first stile cap proximate the first end of the bottom rail; and flowable sealant located in the first end sealant cavity; and the bottom rail defines a first end sealant cavity gap between the side surface of the bottom rail and the first stile cap; wherein the first side sealant cavity gap, the first end sealant cavity gap, and the second side sealant cavity gap extend continuously about the exterior face of the bottom rail between the bottom edge of the first skin, a bottom edge of the first stile cap, and the bottom edge of the second skin. In one or more embodiments, the door panel comprises: a second end sealant cavity located between the side surface of the bottom rail and the second stile cap proximate the second end of the bottom rail; and flowable sealant located in the second end sealant cavity; wherein the bottom rail defines a second end sealant cavity gap between the side surface of the bottom rail and the second stile cap; and wherein the first side sealant cavity gap, the first end sealant cavity gap, the second side sealant cavity gap, and the second end sealant cavity gap extend continuously about a perimeter of the exterior face of the bottom rail between the bottom edge of the first skin, a bottom edge of the first stile cap, the bottom edge of the second skin, and a bottom edge of the second stile cap.

In one or more embodiments of the door panels described herein, the bottom rail comprises a bottom rail height measured between the interior face and the exterior face of the bottom rail; wherein a first side sealant stop is located between the side surface of the bottom rail and an interior surface of the first door skin, wherein the first side sealant stop extends along the side surface between the first end and the second end of the bottom rail, the first side sealant stop contacting the interior surface of the first skin; wherein the first side sealant cavity comprises a first side sealant cavity height measured from the bottom edge of the first skin to the first side sealant stop; and wherein the bottom rail height is greater than the first side sealant cavity height. In one or more embodiments, the first side sealant stop comprises a shoulder located on the side surface between the interior face and the exterior face of the bottom rail.

In one or more embodiments of the door panels described herein, the bottom rail comprises a bottom rail height measured between the interior face and the exterior face of the bottom rail, and wherein the door panel comprises: a first side sealant stop located between the side surface of the bottom rail and an interior surface of the first skin, wherein the first side sealant stop extends along the side surface between the first end and the second end of the bottom rail, the first side sealant stop contacting the interior surface of the first skin; wherein the first side sealant cavity comprises a first side sealant cavity height measured from the bottom edge of the first skin to the first side sealant stop; wherein the bottom rail height is greater than the first side sealant cavity height; and wherein the bottom rail includes a second side sealant stop located between the side surface of the bottom rail and an interior surface of the second skin, wherein the second side sealant stop extends along the side surface between the first end and the second end of the bottom rail, the second side sealant stop contacting the interior surface of the second skin; wherein the second side sealant cavity comprises a second side sealant cavity height measured from the bottom edge of the second skin to the second sealant stop; and wherein the bottom rail height is greater than the second side sealant cavity height. In one or more embodiments, the first side sealant stop comprises a shoulder located on a first portion of the side surface of the bottom rail between the interior face and the exterior face of the bottom rail, and wherein the second side sealant stop comprises a shoulder located on a second portion of the side surface of the bottom rail between the interior face and the exterior face of the bottom rail.

In one or more embodiments of the door panels described herein, the door panel comprises a pressure relief feature proximate the first end of the bottom rail, the pressure relief feature configured to accommodate fluid flow along the interior face from the first end of the bottom rail towards the second end of the bottom rail. In one or more embodiments, the pressure relief feature comprises one or more channels formed in the interior face of the bottom rail. In one or more embodiments, the pressure relief feature comprises one or more channels formed in the interior face of the bottom rail. In one or more embodiments, the one or more channels extend along a length of the bottom rail from the first end to the second end of the bottom rail.

In one or more embodiments of the door panels described herein, the door panel comprises a first pressure relief feature proximate the first end of the bottom rail, the first pressure relief feature configured to accommodate fluid flow along the interior face from the first end of the bottom rail towards the second end of the bottom rail; and wherein the door panel comprises a second pressure relief feature proximate the second end of the bottom rail, the second pressure relief feature configured to accommodate fluid flow along the interior face from the second end of the bottom rail towards the first end of the bottom rail.

In a second aspect, one or more methods of shortening a door panel are described herein in which the door panel includes a first skin and a second skin positioned opposite from each other on opposite major sides of the door panel, a first composite stile positioned between a first side edge of the first skin and a first side edge of the second skin, the first composite stile comprising a first stile cap exposed between the first edge of the first skin and the first edge of the second skin, and a first interior stile located inward from the stile cap, a second composite stile positioned between a second side edge of the first skin and a second side edge of the second skin, the second composite stile comprising a second stile cap exposed between the second edge of the first skin and the second edge of the second skin, and a second interior stile located inward from the second stile cap. The method comprises: removing a selected portion of the door panel proximate a bottom of the door panel, wherein the removing comprises removing a selected portion of each of the first skin, the second skin, the first stile cap, the first interior stile, the second stile cap, and the second interior stile, wherein, after the removing, the first skin and the second skin each comprise a trimmed bottom edge, the first stile cap and the second stile cap each comprise a trimmed stile cap bottom end, and the first interior stile the second interior stile each comprise a trimmed interior stile bottom end; forming a pocket between the first skin, the second skin, the first stile cap, and the second stile cap pocket, wherein forming the pocket comprises removing a second selected portion of each of the first interior stile and the second interior stile after removing the selected portions of the first skin, the second skin, the first stile cap, the first interior stile, the second stile cap, and the second interior stile, wherein the first interior stile comprises a first inset end located inward from the trimmed stile cap bottom end of the first stile cap and the trimmed bottom edges of the first and second skins, and wherein the second interior stile comprises a second inset end located inward from the trimmed stile cap bottom end of the second stile cap and the trimmed bottom edges of the first and second skins; and inserting a bottom rail into the pocket. The bottom rail comprises a first end proximate the first stile cap and a second end proximate the second stile cap, an interior face extending from the first end to the second end, the interior face facing towards the first inset end of the first interior stile and the second inset end of the second interior stile, an exterior face facing away from the first inset end of the first interior stile and the second inset end of the second interior stile, and a side surface extending between the interior face and the exterior face of the bottom rail about a perimeter of each of the interior face and the exterior face. The method further includes providing flowable sealant in a first side sealant cavity located between the side surface of the bottom rail and the first skin; and providing flowable sealant in a second side sealant cavity located between the side surface of the bottom rail and the second skin.

In one or more embodiments of the methods of shortening a door panel as described herein include applying flowable sealant to the first inset end of the first interior stile and the second inset end of the second interior stile before inserting the bottom rail into the pocket.

In one or more embodiments of the methods of shortening a door panel as described herein, providing the flowable sealant in the first side sealant cavity and the second side sealant cavity comprises applying the flowable sealant to the side surface of the bottom rail before inserting the bottom rail into the pocket.

In one or more embodiments of the methods of shortening a door panel as described herein, the bottom rail comprises a shoulder located on the side surface between the interior face and the exterior face, and wherein providing the flowable sealant in the first side sealant cavity and the second side sealant cavity comprises applying the flowable sealant to the side surface of the bottom rail between the shoulder and the exterior face of the bottom rail before inserting the bottom rail into the pocket.

In one or more embodiments of the methods of shortening a door panel as described herein, the bottom rail comprises a first side sealant stop located on the side surface of the bottom rail between the interior face and the exterior face, wherein the first side sealant stop extends along the side surface between the side surface and the first skin to define a first side sealant cavity height of the first side sealant cavity, the first side sealant cavity height measured from the first side sealant stop to the trimmed bottom edge of the first skin; wherein the bottom rail comprises a bottom rail height measured between the interior face and the exterior face of the bottom rail; wherein the bottom rail height is greater than the first side sealant cavity height; and wherein the method comprises applying the flowable sealant to the side surface of the bottom rail between the first side sealant stop and the exterior face of the bottom rail before inserting the bottom rail into the pocket.

Where used herein, the terms “exterior” and “interior” are used in a relative sense, for example, an exterior surface and an interior surface may be used to describe surfaces located on opposite sides of a door panel. In actual use, and exterior surface could be found within the interior of a building or other structure where the surface would conventionally be defined as an interior surface, while an interior surface could be found outside of a building or other structure where the surface would conventionally be defined as an exterior surface.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein.

The above summary is not intended to describe each embodiment or every implementation of the skinned door panels with replacement bottom rails and related methods as described herein. Rather, a more complete understanding of the invention will become apparent and appreciated by reference to the following Description of Illustrative Embodiments and claims in view of the accompanying figures of the drawing.

### BRIEF DESCRIPTION OF THE VIEWS OF THE DRAWING

Each of the figures described herein include axes corresponding to a three-dimensional Cartesian coordinate system to facilitate an understanding of the illustrative embodiments of the invention depicted in the figures and described herein.

FIG. 1 depicts one illustrative embodiment of a door system including a skinned door panel as described herein.

FIG. 2 is a cross-sectional view of the door panel of FIG. 1 taken along line 2-2 in FIG. 1.

FIG. 3 is a cross-sectional view of a bottom edge portion of the skinned door panel of FIG. 1 taken along the X-Y plane at an intermediate location along the Z-axis between the exterior skins of the skinned door panel.

FIG. 4 is a perspective view of a portion of the bottom edge of the skinned door panel of FIGS. 1-3.

FIG. 5 depicts the portion of the bottom edge of the skinned door panel of FIG. 4 after removal of a portion of the door panel (including the original bottom rail) along line T in FIG. 4.

FIG. 6 is a perspective view of the bottom of the skinned door panel of FIG. 5 after removal of a portion of the core material and the interior stile to form a pocket between the skins of the door panel 10, with FIG. 6 further including a replacement bottom rail positioned for insertion into the pocket.

FIG. 7 is a perspective view of the bottom of the skinned door panel of FIG. 6 after insertion of the replacement bottom rail in the pocket formed along the bottom edge of the door panel 10.

FIG. 8 is an enlarged cross-sectional view of a portion of the door panel 10 as depicted in FIG. 4 including the trim line T, with the cross-section being taken in the X-Y plane at a location between the exterior skins (along the Z-axis) of the door panel 10.

FIG. 9 is a cross-sectional view of the door panel 10 as depicted in FIG. 8 after removal of a portion of the bottom of the door panel along trim line T.

FIG. 10 is a cross-sectional view of the door panel 10 as depicted in FIG. 9 after removal of a portion of the core material 12 located between the skins of the door panel 10.

FIG. 11 is a cross-sectional view of the door panel 10 as depicted in FIG. 10 after removal of a portion of the interior stile to form a pocket between the skins along the bottom edge of the door panel 10.

FIG. 12 is a cross-sectional view of the door panel 10 as depicted in FIG. 11 with a replacement bottom rail positioned in the pocket between the skins along the bottom edge of the door panel 10.

FIG. 13 is a view of the bottom edge of the door panel 10 depicting sealant cavities located between the replacement bottom rail and the skins of the door panel 10 as well as the stile cap along one edge of the door panel.

FIG. 14 is an end view of one illustrative embodiment of a replacement bottom rail that may be used in one or more skinned door panels as described herein.

FIG. 15 is a cross-sectional view of the replacement bottom rail of FIG. 14 including sealant applied to the replacement bottom rail.

FIG. 16 is a perspective view of a portion of the replacement bottom rail depicted in FIG. 14.

FIG. 17 is a cross-sectional view of another illustrative embodiment of a skinned door panel, with the cross-sectional view taken in the Y-Z plane at a location between the edges of the skinned door panel, the view depicting the pocket between the skins of the door panel.

FIG. 18 is an enlarged view of the cross-sectional view of FIG. 17 after placement of the replacement bottom rail depicted in FIG. 15 in the pocket formed between the skins of the door panel.

FIG. 19 is a perspective view of a portion of the pocket formed in the skinned door panel of FIGS. 17-18 depicting application of sealant material in the pocket before insertion of the replacement bottom rail into the pocket.

FIG. 20 is a view of the bottom edge of the door panel 210 depicting sealant cavities located between the replacement bottom rail and the skins of the door panel as well as between the stile caps at both edges of the door panel.

FIG. 21 is a perspective view of the bottom edge of the door panel 210 located in a fixed year 270 configured to facilitate sealant placement in the sealant cavities located between the replacement bottom rail and the interior surfaces of the skins and stile caps defining the pocket containing the replacement bottom rail.

### DESCRIPTION OF ILLUSTRATIVE EMBODIMENTS

In the following description of illustrative embodiments, reference is made to the accompanying figures of the drawing which form a part hereof, and in which are shown, by way of illustration, specific embodiments. It is to be understood that other embodiments may be utilized and structural changes may be made without departing from the scope of the present invention.

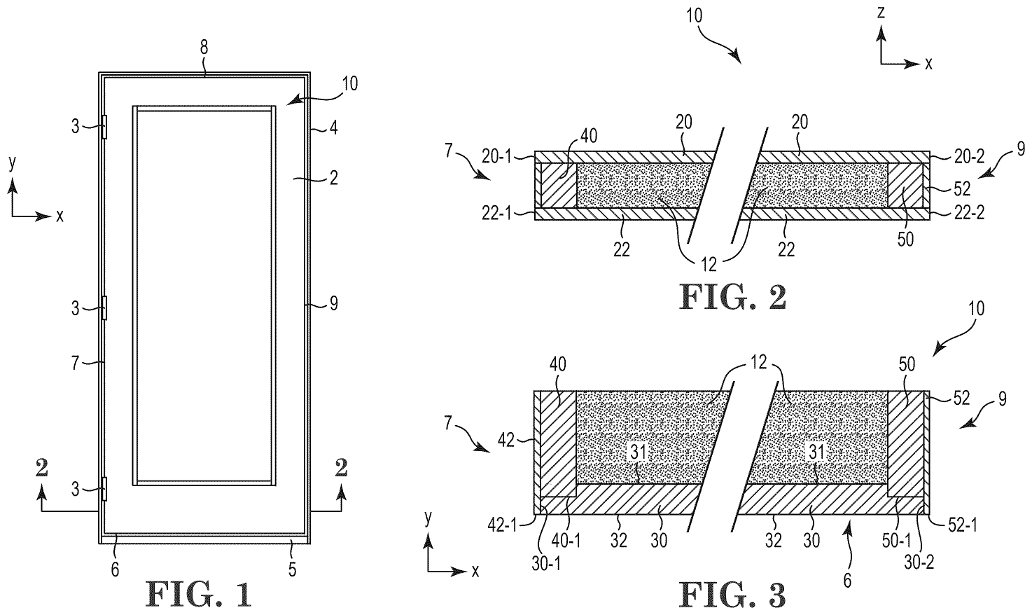

FIG. 1 depicts one illustrative embodiment of a prehung door system including a skinned door panel 10 as described herein. The door panel includes a frame 4 in which the door panel 10 is located, with the door panel 10 being attached to the frame by a set of hinges 3 along one side edge 7 of door panel 10. Door panel 10 further includes a second side edge 9 opposite the side edge 7, bottom edge 6 proximate a sill 5 and a top edge 8 opposite the bottom edge 6.

Although the door panel 10 is depicted as part of a prehung door system, in one or more alternative embodiments, the skinned door panels described herein may or may not be provided as a prehung door system. Although depicted as a single panel door system, the skinned door panels described herein may be used in other door systems including door systems with a sidelight, multi-panel door systems including two or more door panels, etc. Furthermore, although depicted as a hinged or rotating door panel, one or more alternative embodiments of skinned door panels as described herein may be provided as a sliding door panel in, e.g., a patio door system, etc.

FIG. 2 is a cross-sectional view of the skinned door panel 10 of FIG. 1 taken along line 2-2 in FIG. 1. The skinned door panel 10 includes a skin 20 and a skin 22, the skins positioned opposite from each other on opposite major sides of the door panel 10, with each of the skins including a bottom edge and side edges corresponding to the bottom and side edges of the door panel 10.

The side edges of door panel 10 each include a composite stile positioned between the side edges of the skins 20 and 22. In particular, on the left side of the view depicted in FIG. 2, a composite stile including an interior stile 40 and a stile cap 42 are located between skins 20 and 22 proximate side edges 20-1 and 22-1 of skins 20 and 22 while another composite stile including an interior stile 50 and stile cap 52 is located between skins 20 and 22 proximate side edges 20-2 and 22-2 of skins 20 and 22 on the opposite side of the door panel 10.

Door panel 10 further includes a core 12 located between the skins 20 and 22 as well as between interior stiles 40 and 50. As discussed herein, the core 12 may include any suitable material such as, e.g., foam, wood, etc. to provide one or more desired characteristics to the door panel 10 such as, e.g., stiffness, sound deadening, thermal insulation, etc.

One or more embodiments of the door panels as described herein include interior stiles 40 and 50 selected, in large part, for their structural characteristics while the stile caps 42 and 52 are selected for their appearance and resistance to weathering, moisture, etc., with the structural characteristics of the stile caps being a secondary consideration.

With reference to FIG. 3, the depicted illustrative embodiment of door panel 10 also includes a bottom rail 30 positioned along the bottom edge 6 of the door panel 10. The bottom rail 30 may be described as being positioned between the bottom edges of the skins 20 and 22 in a pocket defined by the skins 20 and 22 as well as the interior stiles 40 and 50 and stile caps 42 and 52. The bottom rail 30 may be described as having a first end 30-1 proximate the interior stile 40 and stile cap 42 along with a second end 30-2 proximate the interior stile 50 and stile cap 52.

The bottom rail 30 also includes an interior face 31 extending between the ends 30-1 end 30-2 of the bottom rail 30, the interior face 31 facing towards the interior core 12 of the door panel 10, as well as an exterior face 32 facing away from the interior core 12 of the door panel 10.

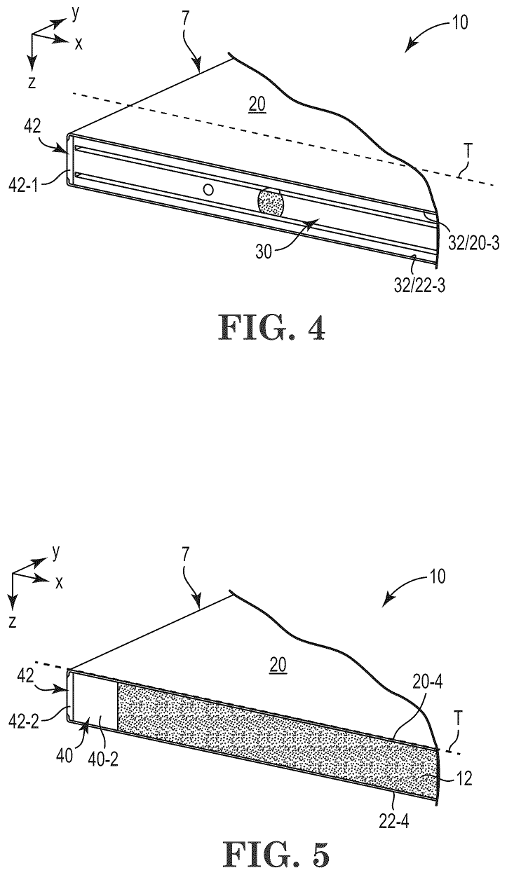

One illustrative method that may be used to provide a replacement bottom rail in a skinned door panel as described herein is illustrated in FIGS. 4-7. With reference to FIG. 4, the door panel 10 is to be cut along trim line T to shorten the door panel, i.e., to reduce the height of the door panel between the bottom edge 6 and top edge 8 (with reference to FIG. 1). As depicted in FIG. 4, door panel 10 includes skin 20, bottom rail 30 with the bottom end 42-1 of stile cap 42 visible at the edge 7 of the door panel 10. Also visible in FIG. 4 are the exterior surface 32 of bottom rail 30 as well as the junction between the exterior surface 32 of bottom rail 30 and each of the bottom edges 20-3 of skin 20 as well as bottom edge 22-3 of skin 22 (of which only the bottom edge 22-3 is visible in FIG. 4).

As discussed herein, the door panel 10 is trimmed along trim line T to shorten the door panel 10. The trimmed door panel 10 is depicted in FIG. 5 where the bottom rail 30 of the door panel 10 is removed such that the core 12 and the interior stile 40 between the skins of the door panel 10 are exposed at the bottom edge of the door panel 10. In particular, interior stile 40 includes a trimmed end 40-2 while stile cap 42 includes a trimmed end 42-2 both of which are flush with the bottom of the core 12 between the skins of the door panel 10. In particular, seat skin 20 includes a trimmed edge 20-4 while the lower skin 22 (not shown in FIG. 5) has a trimmed edge 22-4.

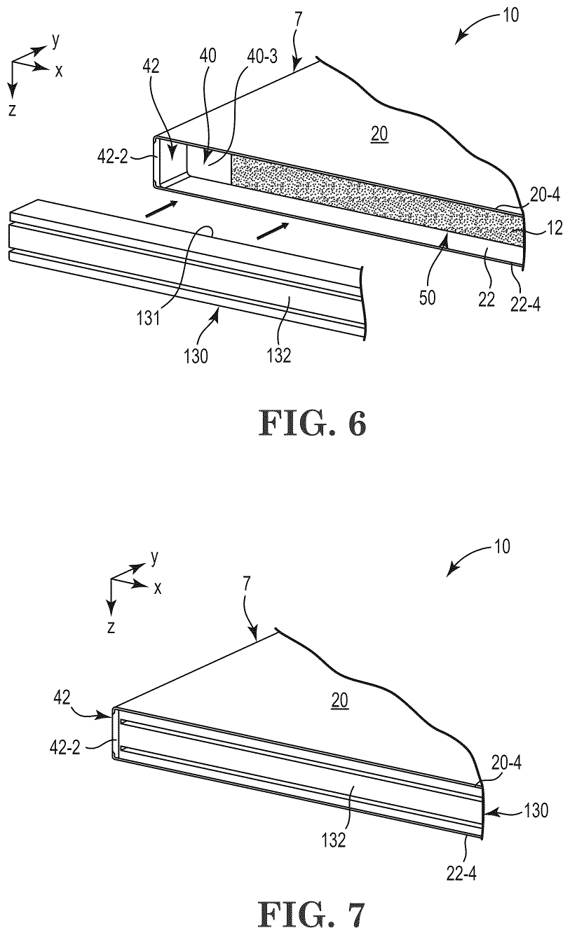

FIG. 6 depicts the door panel 10 after removal of portions of both the core 12 and the interior stile cap 42 form a pocket 50 along the bottom edge of the door panel 10. As discussed in connection with FIG. 5, skin 20 includes a trimmed edge 20-4 while skin 22 includes a trimmed edge 22-4 with the core 12 being inset from the edges 20-4 and 22-4 to define the volume of the pocket 50. Also depicted in FIG. 6 is an inset end 40-3 of interior stile 40 provided by removing a portion of the interior stile 40. In particular, the portion of stile 40 between the trimmed end 40-2 seen in FIG. 5 and the inset end 40-3 depicted in FIG. 6 is removed along with a portion of the core 12 such that the pocket 50 extends from the stile cap 42 across the bottom edge of the door panel 10 to the opposite stile cap 52 (noting that the opposite edge of door panel 10 is not depicted in FIG. 6.

Also depicted in FIG. 6 is one illustrative embodiment of a replacement bottom rail 130 including an exterior surface 132 and an interior surface 131 facing both the core 12 and the inset end 40-3 of interior stile 40. The replacement bottom rail 130 is positioned for insertion into the pocket 50 formed along the bottom edge of the door panel 10.

FIG. 7 depicts the door panel 10 after insertion of the replacement bottom rail 130 into the pocket 50 provided along the bottom edge of the door panel 10. With the replacement bottom rail 130 in position, the exterior surface 132 of the replacement bottom rail faces away from the remainder of the door panel 10 and is positioned between the trimmed edges 20-4 of skin 20 and 22-4 of skin 22. Also seen in FIG. 7 is the end 42-2 of stile cap 42 with the replacement bottom L 130 being positioned inward of the stile cap 42.

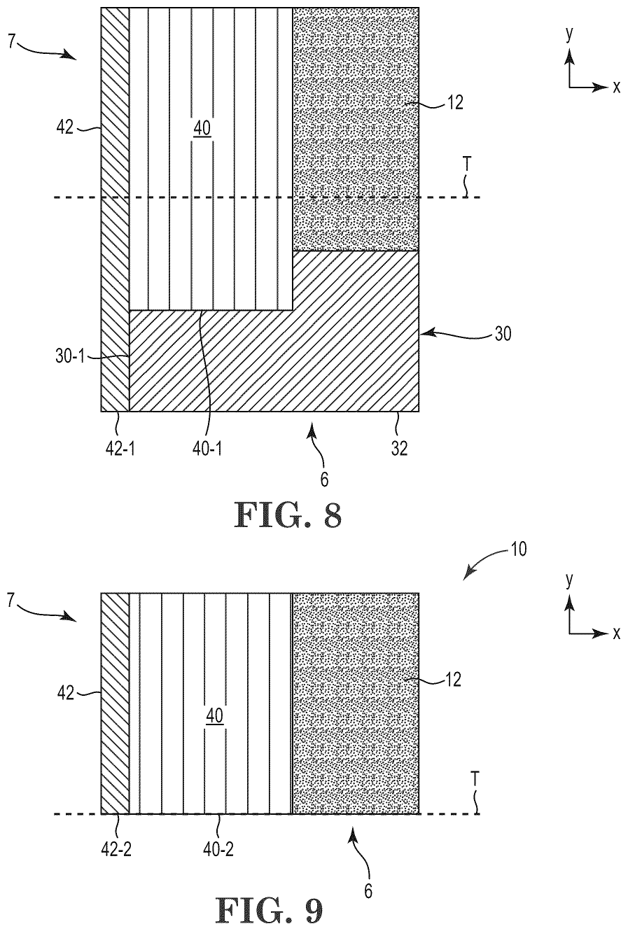

FIGS. 8-13 provide a more detailed schematic depiction of the process of both trimming the bottom edge of the door panel as well as insertion/positioning of the replacement bottom rail in a pocket formed in the bottom edge of the door panel. With reference to FIG. 8, the cross-sectional view depicts the door panel 10 before the process of trimming and bottom rail replacement begin. As seen in FIG. 8, door panel 10 includes a composite stile including both an interior stile 40 and a stile cap 42 located along side edge 7 of door panel 10. The interior stile 40 includes a bottom end of 40-1 while the stile cap 42 includes a bottom end 42-1. The bottom end 40-1 of interior stile 40 is positioned inward from the bottom edge 6 of the door panel 10 while the bottom end 42-1 of stile cap 42 is exposed at the bottom edge of the door panel 10.

A portion of the core 12 of the door panel is also depicted in FIG. 8 along with a portion of the bottom rail 30 including an exterior face 32 facing away from the remainder of the door panel. Although a portion of the bottom rail 30 could be removed to shorten the door panel 10, the distance between the exterior surface 32 of bottom rail 30 and the bottom end 40-1 of interior stile 40 limit the distance over which the door panel 10 could have its height reduced without exposing the bottom end 40-1 of the interior stile 40 which, as discussed herein, can result in moisture penetration into the interior of the door panels between the skins that can result in swelling mold formation, rot, etc.—all of which can lead to premature failure of the door panels.

The door panel 10 is depicted in FIG. 9 after trimming of the door panel 10 along trim line T as depicted in FIG. 8. Because trim line T is located above the bottom end 40-1 of the interior stile 40, a trimmed end 40-2 is formed on the bottom of stile 40 along with a trimmed end 42-2 on stile cap 42. A portion of the core 12 of the door panel 10 is also moved as well as portions of the skins (not shown) are also removed during the trimming process.

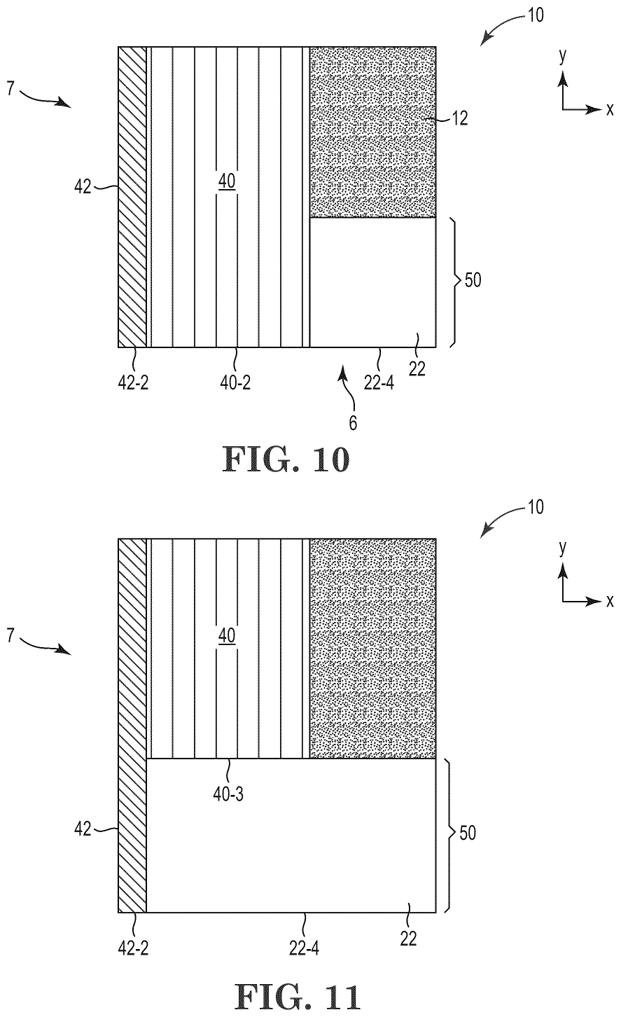

FIG. 10 depicts another step in the process of providing a replacement bottom rail on door panel 10. In particular, a portion of the core 12 of the door panel 10 is removed such that, in the depicted view, a portion of the skin 22 along with a trimmed edge 22-4 of skin 22 are exposed as depicted in FIG. 10. The portion of the core 12 of the door panel 10 removed forms a portion of the pocket 50 into which a replacement bottom rail will be placed as described herein.

With reference to FIG. 11, a portion of the interior stile 40 is moved to form an inset end 40-3 of interior stile 40 while leaving the stile cap 42 and its trimmed end 42- to be intact to protect the side edge 7 of the door panel 10. The portion of the interior stile 40 between trimmed end 40-2 and inset end 40-3 as well as the portion of the core 12 removed to form pocket 50 into which a replacement bottom rail can be placed may be removed by any suitable process or technique, for example, milling, routing, chiseling, etc.

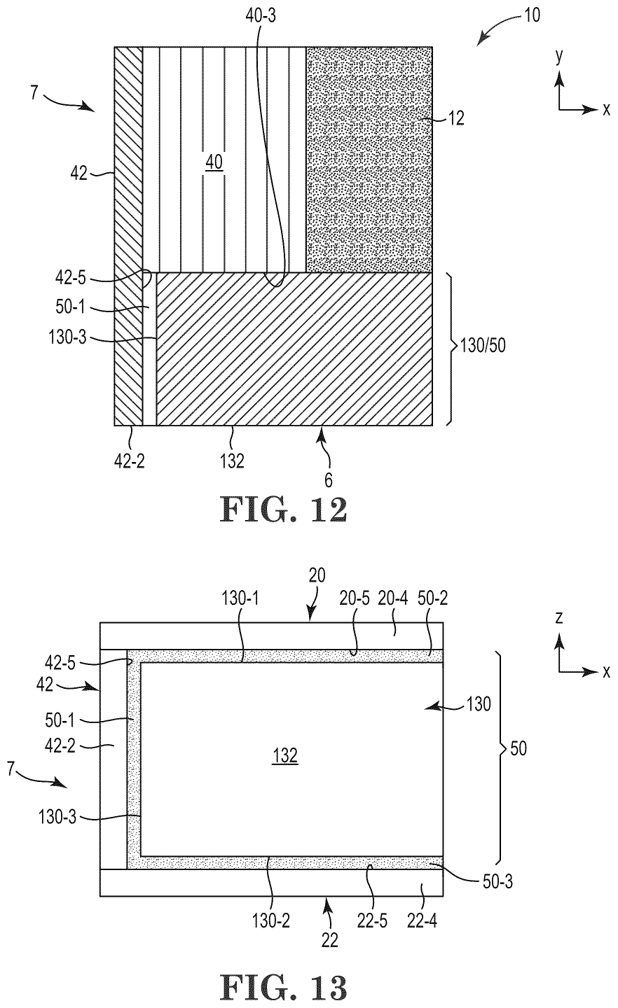

FIG. 12 depicts a replacement bottom rail 130 located within the pocket 50 depicted in FIG. 11. The replacement bottom rail 130 includes an exterior face that faces away from the remainder of the door panel 10 as well as an interior face 131 facing the inset end 40-3 of interior stile 40 as well as the remainder of the core material 12 of door panel 10. Replacement bottom rail 130 also includes an end 130-3 facing an interior surface 42-5 of the stile cap 42.

In the depicted illustrative embodiment, an end sealant cavity 50-1 being formed between the end 130-3 of the bottom rail 130 and the interior surface 42-5 of the stile cap 42. The end sealant cavity 50-1 can provide a volume in which sealant material can be located to limit or prevent moisture from reaching the interior stile 40 of the door panel 10.

FIG. 13 is a view of the bottom edge of the door panel 10 depicting sealant cavities located between the replacement bottom rail 130 and the skins 20 and 22 of the door panel 10 as well as the stile cap 42 along one edge of the door panel 10. In particular, with replacement bottom rail 130 located in pocket 50 between skins 20 and 22, the bottom rail 130 can be described as defining a first sealant cavity 50-2 between a side surface 130-1 on replacement bottom rail 130 and the interior surface 20-5 of skin 20 as well as a second sealant cavity 50-3 located between a side surface 130-2 on replacement bottom rail 130 and the interior surface 22-5 of skin 22. The side sealant cavities 50-2 and 50-3 may be in fluid communication with the end sealant cavity 50-1 formed between the end 130-3 of replacement bottom rail 130 and the interior surface 42-5 of stile cap 42.

The sealant used in the sealant cavities formed by the replacement bottom rails in pockets of skinned door panels as described herein may take a variety of forms. In one or more embodiments, the sealant may be described as a flowable sealant that can flow into and/or take the shape of the sealant cavities formed by the replacement bottom rails and pockets in skinned door panels as described herein. When cured, hardened, dried, etc., the flowable sealant resists or prevents the passage of liquid water, water vapor, air, etc. and also bonds or adheres to the surfaces of the bottom rails and door panel skins to retain the bottom rail in place and enhance structural integrity of the door panel proximate its bottom edge. In one or more embodiments, the flowable sealant may be injected, extruded, etc. onto components of the door panels and/or into the sealant cavities. Examples of some potentially suitable flowable sealants may include, but are not limited to, methyl methacrylate sealants/adhesives, 1 component urethane sealants/adhesives, 2 component urethane sealants/adhesives, 2 component epoxy-based sealants/adhesives, hotmelt sealants/adhesives, 1- & 2-part acrylic sealants, hybrid polymer sealants/adhesives (e.g., SPUR and MS Polymer), 1 component silicone sealants/adhesives (including, e.g., structural silicone adhesives), 2 component silicone sealants/adhesives (including, e.g., structural silicone adhesives), solvent based sealants/adhesives, water based sealant/adhesives, etc.

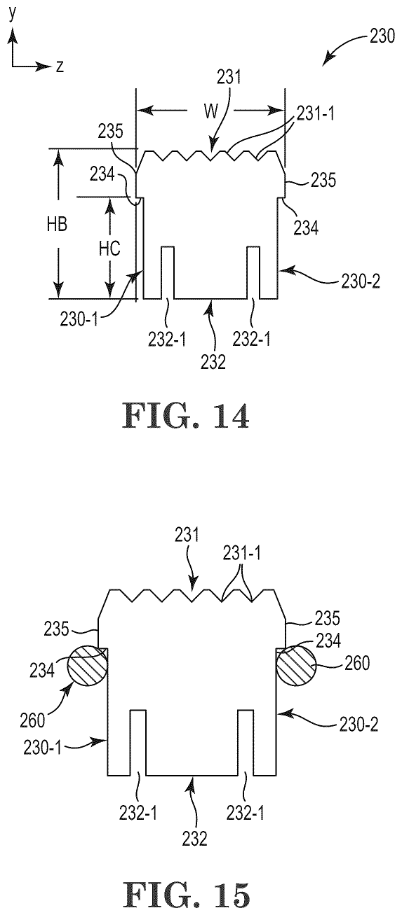

FIGS. 14-16 depict another illustrative embodiment of a replacement bottom rail 230 that may be used in connection with the skinned door panels described herein. FIG. 14 is an end view of the replacement bottom rail 230 which includes an exterior face 232 and an interior face 231. Exterior face 232 includes channels 232-1 that may be used to secure features such as sweeps or other flexible seals along the bottom edge of a door panel in which the replacement bottom rail 230 is provided.

The illustrative embodiment of replacement bottom rail 230 also includes a pair of side surfaces 230-1 and 230-2 extending between the interior face 231 and the exterior face 232 along the sides of the replacement bottom rail 230. When installed in a pocket along the bottom edge of a skinned door panel as described herein, the side surfaces 230-1 and 230-2 would face the interior surfaces of the opposing skins on the door panel.

The replacement bottom rail 230 as depicted in FIG. 14 may be described as having a bottom rail height HB measured between the interior face 231 and the exterior face 232 of the bottom rail 230. In general, the bottom rail height HB will be equal to or less than the depth of a pocket into which the bottom rail 230 is to be inserted unless it is desired that a portion of the bottom rail extend out of the pocket and passed the bottom edges of the skins forming the sides of the pocket.

The depicted illustrative embodiment of replacement bottom rail 230 also includes a sealant stop 234 located on each of the side surfaces 230-1 and 230-2 of the bottom rail 230. In one or more embodiments, the sealant stops 234 may preferably extend along the entire length of the bottom rail 230 such that the sealant stops 234 extend along essentially the entire length of the bottom edge of the door panel into which replacement bottom rail 230 is inserted.

The sealant stops 234 may, in one or more embodiments, preferably be located at an intermediate location between the interior face 231 and the exterior face 232 of the bottom rail 230. The location of the sealant stops 234 defines a sealant cavity height CH on each of the side surfaces 230-1 and 230-2 of the bottom rail 230. In the depicted embodiment, the sealant stops 234 define the same sealant cavity height HC on both of the side surfaces 230-1 and 230-2, but it should be understood that in one or more alternative embodiments the sealant cavity height HC may not necessarily be equal on opposite sides of the bottom rail 230.

In the depicted illustrative embodiment, the sealant stops 234 may be in the form of shoulders 234 formed in the side surfaces 230-1 and 230-2 of bottom rail 230. The shoulders 234 reduce the width of the replacement bottom rail 230 as measured along the Z-axis. In one or more embodiments, it may be preferred that the bottom rail 230 have a width W as depicted in FIG. 14 that is equal to the distance between the interior surfaces of the skins of a door panel into which the bottom rail 230 is inserted. This is not, however, required.

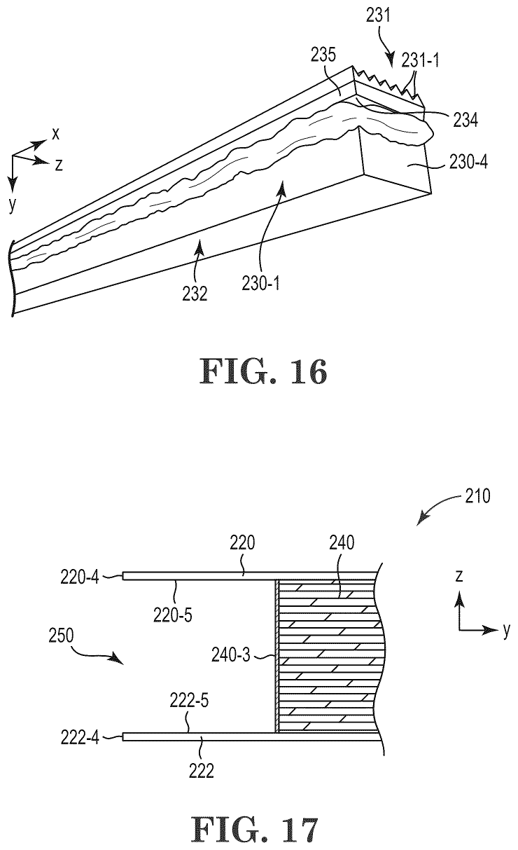

FIGS. 15 and 16 are alternate views of the replacement bottom rail 230 with FIG. 15 being a cross-sectional view of the bottom rail 230 depicting sealant 260 positioned proximate the shoulders 234 located on the opposite sides 230-1 and 230-2 of the replacement bottom rail 230.

FIG. 17 is a cross-sectional view of one illustrative embodiment of a skinned door panel 210, with the cross-sectional view taken in the Y-Z plane at a location in the interior stile 240 of the skinned door panel 210 to depict the pocket 250 between the interior surfaces 220-5 and 222-5 of the skins 220 and 222 of the door panel 210. As depicted in FIG. 17, the pocket 250 has a pocket depth measured along the Y axis between either of the bottom edges 220-4 or 222-4 and the inset end 240-3 of the stile 240.

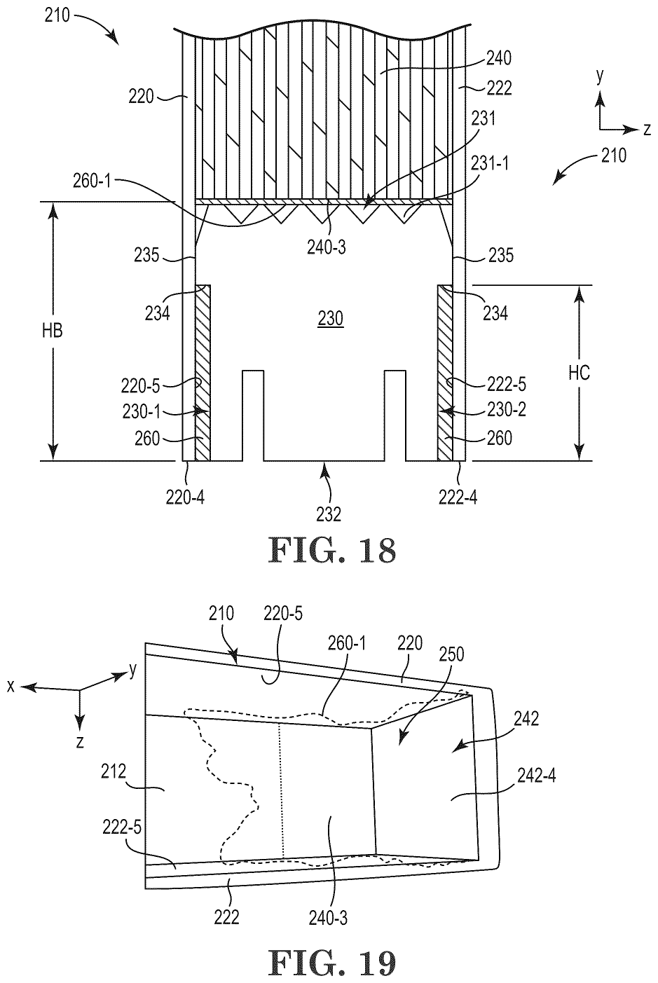

FIG. 18 is an enlarged view depicting the replacement bottom rail 230 of FIGS. 14-16 in the pocket of door panel 210 as depicted in FIG. 17. As seen in FIG. 18, the replacement bottom rail 230 includes an interior face 231 facing the inset end 240-3 of the interior stile 240 and exterior face 232 facing away from the inset end 240-3 of the interior stile 240 (along with the remainder of the door panel 210).

Also depicted in FIG. 18 is sealant 260 located in side sealant cavities formed between the side surfaces 230-1 and 230-2 of replacement bottom rail 230 and the interior surfaces 220-5 and 222-5 of the skins 220 and 222 of door panel 210. As discussed herein, the side sealant cavities have a cavity height HC measured along the Y-axis from the exterior surface 232 of the bottom rail to the sealant stops 234 on the side surfaces 230-1 and 230-2 of the replacement bottom rail 230. Also as discussed herein, the replacement bottom rail 230 defines a bottom rail height HB measured between the exterior surface 232 and interior surface 231 of the replacement bottom rail 230.

As is also discussed herein, in one or more embodiments such as the depicted illustrative embodiment, the cavity height HC is less than the bottom rail height HB. In one or more embodiments, limiting the cavity height HC may assist the sealant 262 form a water resistant, preferably waterproof, barrier to the ingress of moisture into the pocket in which the replacement bottom rail 230 is located by providing a defined volume into which the sealant 260 must be provided.

While the replacement bottom rails described herein provide side sealant cavities, at least a portion of the replacement bottom rails in one or more embodiments of the replacement bottom rails may have a width (e.g., width W as depicted in FIG. 14) that is substantially equal to the width between the interior surfaces 220-5 and 222-5 of the skins 220 and 222. In the depicted illustrative embodiment, the replacement bottom rail 230 includes spacer surfaces 235 that define the replacement bottom rail width W and, as such, are positioned against and in contact with the interior surfaces 220-5 and 222-5 of the skins 220 and 222.

Like the sealant cavities, the spacer surfaces 235 are located between the interior surface 231 and exterior surface 232 of the replacement bottom rail 230. More specifically, the spacer surfaces 235 are located between the sealing cavity and the interior surface 231 of the replacement bottom rail 230. Positioning at least a portion of the replacement bottom rail 230 in contact with the interior surfaces 220-5 and 222-5 of the skins 220 and 222 may enhance structural integrity of the skinned door panel 210 along the bottom edge thereof.

With reference to FIGS. 14, 15, and 18, the depicted illustrative embodiment of a skinned door panel with a replacement bottom rail 230 includes at least one pressure relief feature configured to accommodate fluid flow along the interior face 231 of the replacement bottom rail 230. In particular, the pressure relief feature allows air to escape as the replacement bottom rail 230 is inserted into the pocket 250 along the bottom edge of the door panel 210.

In one or more embodiments, the pressure relief feature may be located proximate one end of the replacement bottom rail 230 (i.e., at or near one of the stile caps defining the ends of the pocket in the skinned door panel 210). In one or more embodiments, a pressure relief feature may be located at both ends of the replacement bottom rail 230 (i.e., at or near each of the stile caps defining the ends of the pocket in the skinned door panel 210).

In the depicted illustrative embodiment, the pressure relief features may take the form of channels 231-1 formed into the interior face 231 of the replacement bottom rail 230. In one or more embodiments, the channels 231-1 may extend along the entire length of the replacement bottom rail 230 from one end to the other (i.e., along the X axis). Although the depicted pressure relief features are in the form of channels 231-1, other pressure relief features could be provided in replacement bottom rails used in skinned door panels as described herein. Some potential alternative examples may include, for example, knurling on the interior face 231, posts or spacers on the interior face 231, etc. In still other potential embodiments, the pressure relief features may be in the form of features and/or articles provided on or in the inset ends of the stiles at each end of the pocket and/or in the material forming the core of the skinned door panel.

With reference to FIG. 19, one or more embodiments of the skinned door panels having replacement bottom rails as described herein may include additional sealant applied in the pocket to facilitate and/or ensure sealing of the inset ends of the stiles located along the edges of the door panels. As depicted in FIG. 19 sealant 260-1 is provided on the inset end 240-3 of a stile terminating in the pocket 250. The sealant material 260-1 extend onto the court 212 as well as onto the interior surfaces 220-5 and 222-5 of the skins 220 and 222 as well as onto the interior surface 242-4 of the stile cap 242. That additional sealant may, when combined with the sealant provided on the replacement bottom rail before insertion into the pocket 250, facilitate and/or insurer sealing of the inset ends of the stiles of the door panels as described herein.

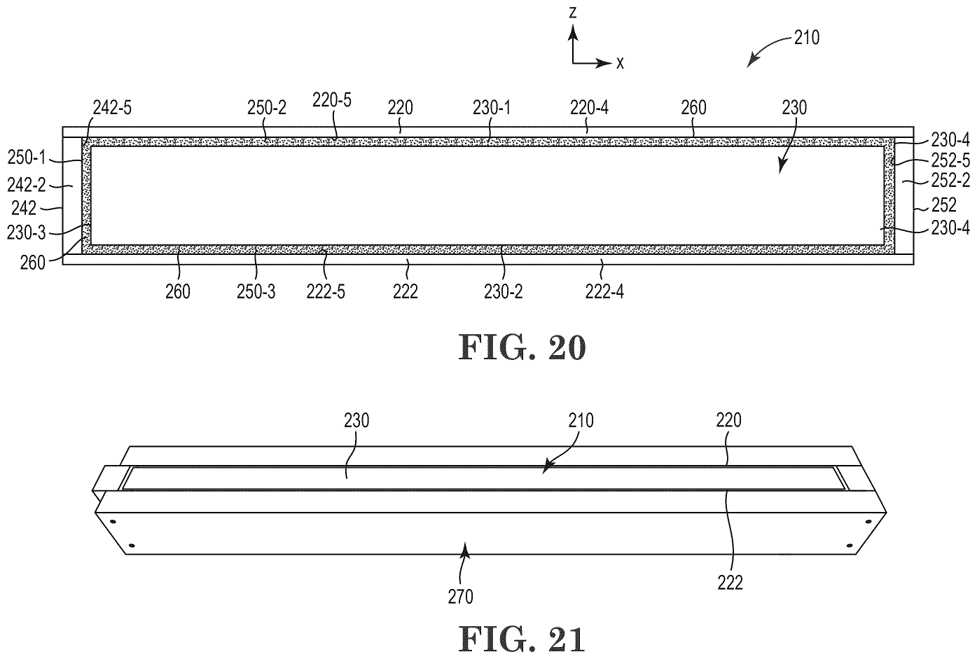

FIG. 20 is an end view of the bottom edge of the skinned door panel 210. In the depicted illustrative embodiment, the trimmed edges 220-4 and 222-4 of the skins 220 and 222, along with the trimmed edges 242-2 and 252-2 of the stile caps 242 and 252, define the pocket in which the replacement bottom rail 230 is positioned.

In that pocket, side surface 230-1 of the replacement bottom rail 230 faces the interior surface 220-5 of skin 220 to define the side sealant cavity 250-2 in which sealant 260 is located. Side surface 230-2 of replacement bottom rail 230 faces the interior surface 222-5 of skin 222 to define the side sealant cavity 250-3 in which sealant 260 is also located.

At the left end of the bottom edge of the skinned door panel 210, end surface 230-3 of replacement bottom rail 230 faces interior surface 242-5 of stile cap 242 to define the end sealant cavity 250-1 in which sealant 260 is also located. At the right end of the bottom edge of the skinned door panel 210, end surface 230-4 of replacement bottom rail 230 faces interior surface 252-5 of stile cap 252 to define the end sealant cavity 250-4 in which sealant 260 is also located.

In one or more embodiments the sealant cavities in the sealant 260 located therein may be described as extending continuously from the side sealant cavities 250-2 and 250-3 through the end sealant cavities 250-1 and 250-4. The combination of sealant cavities 250-1, 250-2, 250-3, and 250-4 along with the sealant 260 contained therein surround the sides and ends of the replacement bottom rail 232 provide a seal along the bottom edge of the skinned door panel 210 that provides robust protection against moisture penetration into the interior of the door panel 210.

FIG. 21 depicts a fixture 270 that may optionally be used to prevent expansion of the skins 220 and 222 by the sealant 260 located in the sealant cavities surrounding the replacement bottom rail 230. Fixture 270 may also facilitate higher pressure injection/delivery of sealant into the sealant cavities after the replacement bottom rail 230 is fully seated in the pocket along the bottom edge of the skinned door panel 210.

The various components used in the skinned door panels with replacement bottom rails described herein may be constructed of any suitable material or combination of materials including polymers, metals, composites, wood, ceramics, etc. The particular materials used need only perform the functions of the various components as described herein and suitable choices for the materials will be known to those of skill in the art.

The complete disclosure of the patents, patent documents, and publications identified herein are incorporated by reference in their entirety as if each were individually incorporated. To the extent there is a conflict or discrepancy between this document and the disclosure in any such incorporated document, this document will control.

Illustrative embodiments of door systems including one or more embodiments of the skinned door panels with replacement bottom rails and related methods are discussed herein with some possible variations described. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof. It should also be understood that this invention also may be suitably practiced in the absence of any element not specifically disclosed as necessary herein.

1. A door panel comprising:
a first skin and a second skin positioned opposite from each other on opposite major sides of the door skin, wherein each of the first skin and the second skin comprise a bottom edge, a first side edge, and a second side edge;
a first composite stile positioned between the first side edges of the first skin and the second skin, the first composite stile comprising a first stile cap exposed between the first edge of the first skin and the first edge of the second skin, and a first interior stile located inward from the first stile cap, wherein the first stile cap extends from the bottom edges of the first skin and the second skin to a top edge of the door panel, and wherein the first interior stile comprises a first inset end spaced inward from the bottom edges of the first skin and the second skin and a bottom end of the first stile cap;
a second composite stile positioned between the second side edges of the first skin and the second skin, the second composite stile comprising a second stile cap exposed between the second edge of the first skin and the second edge of the second skin, and a second interior stile located inward from the second stile cap, wherein the second stile cap extends from the bottom edges of the first skin and the second skin to a top edge of the door panel, and wherein the second interior stile comprises a second inset end spaced inward from the bottom edges of the first skin and the second skin and a bottom end of the second stile cap; and
a bottom rail located between the bottom edges of the first skin and the second skin, the bottom rail positioned in a pocket defined by the first skin, the second skin, the inset end of the first interior stile, the inset end of the second interior stile, the first stile cap, and the second stile cap, wherein the bottom rail comprises:
a first end proximate the first stile cap and a second end proximate the second stile cap,
an interior face extending from the first end to the second end, the interior face facing towards the first inset end of the first interior stile and the second inset end of the second interior stile,
an exterior face facing away from the first bottom end of the first interior stile and the second bottom end of the second interior stile, and
a side surface extending between the interior face and the exterior face of the bottom rail about a perimeter of each of the interior face and the exterior face;
a first side sealant cavity located between the side surface of the bottom rail and the first skin;
a second side sealant cavity located between the side surface of the bottom rail and the second skin; and
flowable sealant located in the first side sealant cavity and the second side sealant cavity.

2. A door panel according to claim 1, wherein door panel comprises:
a first end sealant cavity located between the side surface of the bottom rail and the first stile cap proximate the first end of the bottom rail;
a second end sealant cavity located between the side surface of the bottom rail and the second stile cap proximate the second end of the bottom rail; and
flowable sealant located in the first end sealant cavity and the second end sealant cavity.

3. A door panel according to claim 2, wherein the first side sealant cavity, the second side sealant cavity, and the first end sealant cavity comprise a continuous sealant cavity, and wherein the flowable sealant in the first side sealant cavity, the second side sealant cavity, and the first end sealant cavity extends continuously from the first side sealant cavity to the second side sealant cavity through the first end sealant cavity.

4. A door panel according to claim 2, wherein the first side sealant cavity, the second side sealant cavity, the first end sealant cavity, and the second end sealant cavity comprise a continuous sealant cavity, and wherein the flowable sealant in the first side sealant cavity, the second side sealant cavity, the first end sealant cavity, and the second end sealant cavity extends continuously from the first side sealant cavity to the second side sealant cavity through the first end sealant cavity and the second end sealant cavity.

5. A door panel according to claim 1, wherein the bottom rail defines a first side sealant cavity gap between the side surface of the bottom rail and the first skin along the bottom edge of the first skin and a second side sealant cavity gap between the side surface of the bottom rail and the second skin along the bottom edge of the second skin.

6. A door panel according to claim 5, wherein the door panel comprises:
a first end sealant cavity located between the side surface of the bottom rail and the first stile cap proximate the first end of the bottom rail;
flowable sealant located in the first end sealant cavity;
wherein the bottom rail defines a first end sealant cavity gap between the side surface of the bottom rail and the first stile cap;
and wherein the first side sealant cavity gap, the first end sealant cavity gap, and the second side sealant cavity gap extend continuously about the exterior face of the bottom rail between the bottom edge of the first skin, a bottom edge of the first stile cap, and the bottom edge of the second skin.

7. A door panel according to claim 6, wherein the door panel comprises:
a second end sealant cavity located between the side surface of the bottom rail and the second stile cap proximate the second end of the bottom rail;
flowable sealant located in the second end sealant cavity;
wherein the bottom rail defines a second end sealant cavity gap between the side surface of the bottom rail and the second stile cap;
and wherein the first side sealant cavity gap, the first end sealant cavity gap, the second side sealant cavity gap, and the second end sealant cavity gap extend continuously about a perimeter of the exterior face of the bottom rail between the bottom edge of the first skin, a bottom edge of the first stile cap, the bottom edge of the second skin, and a bottom edge of the second stile cap.

8. A door panel according to claim 1, wherein the bottom rail comprises a bottom rail height measured between the interior face and the exterior face of the bottom rail;
wherein a first side sealant stop is located between the side surface of the bottom rail and an interior surface of the first door skin, wherein the first side sealant stop extends along the side surface between the first end and the second end of the bottom rail, the first side sealant stop contacting the interior surface of the first skin;
wherein the first side sealant cavity comprises a first side sealant cavity height measured from the bottom edge of the first skin to the first side sealant stop;
and wherein the bottom rail height is greater than the first side sealant cavity height.

9. A door panel according to claim 8, wherein the first side sealant stop comprises a shoulder located on the side surface between the interior face and the exterior face of the bottom rail.

10. A door panel according to claim 1, wherein the bottom rail comprises a bottom rail height measured between the interior face and the exterior face of the bottom rail, and wherein the door panel comprises:
a first side sealant stop located between the side surface of the bottom rail and an interior surface of the first skin, wherein the first side sealant stop extends along the side surface between the first end and the second end of the bottom rail, the first side sealant stop contacting the interior surface of the first skin;
wherein the first side sealant cavity comprises a first side sealant cavity height measured from the bottom edge of the first skin to the first side sealant stop;
wherein the bottom rail height is greater than the first side sealant cavity height;
a second side sealant stop located between the side surface of the bottom rail and an interior surface of the second skin, wherein the second side sealant stop extends along the side surface between the first end and the second end of the bottom rail, the second side sealant stop contacting the interior surface of the second skin;
wherein the second side sealant cavity comprises a second side sealant cavity height measured from the bottom edge of the second skin to the second sealant stop;
and wherein the bottom rail height is greater than the second side sealant cavity height.

11. A door panel according to claim 10, wherein the first side sealant stop comprises a shoulder located on a first portion of the side surface of the bottom rail between the interior face and the exterior face of the bottom rail, and wherein the second side sealant stop comprises a shoulder located on a second portion of the side surface of the bottom rail between the interior face and the exterior face of the bottom rail.

12. A door panel according to claim 1, wherein the door panel comprises a pressure relief feature proximate the first end of the bottom rail, the pressure relief feature configured to accommodate fluid flow along the interior face from the first end of the bottom rail towards the second end of the bottom rail.

13. A door panel according to claim 1, wherein the door panel comprises a first pressure relief feature proximate the first end of the bottom rail, the first pressure relief feature configured to accommodate fluid flow along the interior face from the first end of the bottom rail towards the second end of the bottom rail;
and wherein the door panel comprises a second pressure relief feature proximate the second end of the bottom rail, the second pressure relief feature configured to accommodate fluid flow along the interior face from the second end of the bottom rail towards the first end of the bottom rail.

14. A door panel according to claim 12, wherein the pressure relief feature comprises one or more channels formed in the interior face of the bottom rail.

15. A door panel according to claim 14, wherein the one or more channels extend along a length of the bottom rail from the first end to the second end of the bottom rail.

16. A method of shortening a door panel comprising a first skin and a second skin positioned opposite from each other on opposite major sides of the door panel, a first composite stile positioned between a first side edge of the first skin and a first side edge of the second skin, the first composite stile comprising a first stile cap exposed between the first edge of the first skin and the first edge of the second skin, and a first interior stile located inward from the stile cap, a second composite stile positioned between a second side edge of the first skin and a second side edge of the second skin, the second composite stile comprising a second stile cap exposed between the second edge of the first skin and the second edge of the second skin, and a second interior stile located inward from the second stile cap, the method comprising:
removing a selected portion of the door panel proximate a bottom of the door panel, wherein the removing comprises removing a selected portion of each of the first skin, the second skin, the first stile cap, the first interior stile, the second stile cap, and the second interior stile, wherein, after the removing, the first skin and the second skin each comprise a trimmed bottom edge, the first stile cap and the second stile cap each comprise a trimmed stile cap bottom end, and the first interior stile the second interior stile each comprise a trimmed interior stile bottom end;
forming a pocket between the first skin, the second skin, the first stile cap, and the second stile cap pocket, wherein forming the pocket comprises removing a second selected portion of each of the first interior stile and the second interior stile after removing the selected portions of the first skin, the second skin, the first stile cap, the first interior stile, the second stile cap, and the second interior stile, wherein the first interior stile comprises a first inset end located inward from the trimmed stile cap bottom end of the first stile cap and the trimmed bottom edges of the first and second skins, and wherein the second interior stile comprises a second inset end located inward from the trimmed stile cap bottom end of the second stile cap and the trimmed bottom edges of the first and second skins;
inserting a bottom rail into the pocket, wherein the bottom rail comprises:
a first end proximate the first stile cap and a second end proximate the second stile cap,
an interior face extending from the first end to the second end, the interior face facing towards the first inset end of the first interior stile and the second inset end of the second interior stile,
an exterior face facing away from the first inset end of the first interior stile and the second inset end of the second interior stile, and
a side surface extending between the interior face and the exterior face of the bottom rail about a perimeter of each of the interior face and the exterior face;
providing flowable sealant in a first side sealant cavity located between the side surface of the bottom rail and the first skin; and
providing flowable sealant in a second side sealant cavity located between the side surface of the bottom rail and the second skin.

17. A method according to claim 16, wherein the method comprises applying flowable sealant to the first inset end of the first interior stile and the second inset end of the second interior stile before inserting the bottom rail into the pocket.

18. A method according to claim 16, wherein providing the flowable sealant in the first side sealant cavity and the second side sealant cavity comprises applying the flowable sealant to the side surface of the bottom rail before inserting the bottom rail into the pocket.

19. A method according to claim 16, wherein the bottom rail comprises a shoulder located on the side surface between the interior face and the exterior face, and wherein providing the flowable sealant in the first side sealant cavity and the second side sealant cavity comprises applying the flowable sealant to the side surface of the bottom rail between the shoulder and the exterior face of the bottom rail before inserting the bottom rail into the pocket.

20. A method according to claim 16, wherein the bottom rail comprises a first side sealant stop located on the side surface of the bottom rail between the interior face and the exterior face, wherein the first side sealant stop extends along the side surface between the side surface and the first skin to define a first side sealant cavity height of the first side sealant cavity, the first side sealant cavity height measured from the first side sealant stop to the trimmed bottom edge of the first skin;
wherein the bottom rail comprises a bottom rail height measured between the interior face and the exterior face of the bottom rail;
wherein the bottom rail height is greater than the first side sealant cavity height;
and wherein the method comprises applying the flowable sealant to the side surface of the bottom rail between the first side sealant stop and the exterior face of the bottom rail before inserting the bottom rail into the pocket.
